(19) United States
(12) Patent Application Publication
(10) Pub. No.: US 2014/0117920 A1
(43) Pub. Date: May 1, 2014

(54) MOTOR DRIVING DEVICE AND METHOD

(71) Applicant: SAMSUNG ELECTRO-MECHANICS CO., LTD., Suwon (KR)

(72) Inventor: Joong Jin NAM, Suwon (KR)

(73) Assignee: SAMSUNG ELECTRO-MECHANICS CO., LTD., Suwon (KR)

(21) Appl. No.: 14/039,904

(22) Filed: Sep. 27, 2013

(30) Foreign Application Priority Data
Oct. 31, 2012 (KR) 10-2012-0122612

(51) Int. Cl. H02P 23/00

(52) U.S. Cl. CPC H02P 23/00
USPC 318/722

(57) ABSTRACT

There are provided a motor driving device and method. The motor driving device includes: an operation controlling unit generating a pulse width modulation (PWM) signal for controlling an operation of a motor; a driving controlling unit generating a short pulse signal using the PWM signal transferred from the operation controlling unit; and a power supplying unit supplying power to the motor using the short pulse signal, wherein the driving controlling unit controls the PWM signal depending on a control signal provided from the outside to generate the short pulse signal.

### CROSS-REFERENCE TO RELATED APPLICATIONS

This application claims the priority of Korean Patent Application No. 10-2012-0122612 filed on Oct. 31, 2012, in the Korean Intellectual Property Office, the disclosure of which is incorporated herein by reference.

### BACKGROUND OF THE INVENTION

1. Field of the Invention

The present invention relates to a motor driving device and method, and more particularly, to a motor driving device and method capable of decreasing a development period by arbitrarily controlling a delay time to simplify a circuit.

2. Description of the Related Art

Recently, domestic, commercial and industrial demand for electrical devices and electronic devices has increased. These devices may include a driving circuit for driving a specific operation of device element. An example of these devices may include a motor.

Generally, a speed of motor in which speed is capable of being controlled may be controlled through control of a duty value of a pulse width modulation (hereinafter, referred to as PWM) signal. The duty value of the PWM signal may be determined depending on a ratio of a turn-on time, at which the signal has a high value in one period of the signal, to a turn-off time, at which the signal has a low value in one period of the signal, and a rotational speed of the motor may be in proportion to the duty value of the PWM signal.

Particularly, in a motor operated at a high voltage, stability in driving the motor and electrical efficiency of a circuit are required. To this end, an on-time of a pulse may be decreased using a short pulse generating circuit without directly using the PWM signal, thereby decreasing an average amount of current required for driving the motor.

That is, in the short pulse generating circuit, a scheme of connecting several delay cells having a fixed delay time in series with each other to control a delay is used. However, in this scheme, there are many changes depending on a process condition, such that it may be difficult to precisely control a short pulse signal. Particularly, after an integrated circuit is manufactured, it may be difficult to control a control signal, and a development time thereof may be relatively long.

In the following Related Art Documents, Patent Document 1 relates to a motor driving technology, and more particularly, to a motor driving technology enabling a vibration motor to operate in a relatively short period of time, and Patent Document 2 only discloses a technology of controlling driving of an ultrasonic motor by controlling a number of pulses provided thereto. As a result, Patent Document 1 and Patent Document 2 do not disclose a technology for precisely controlling a circuit generating a short pulse by controlling a delay time.

### RELATED ART DOCUMENT

(Patent Document 1) Korean Patent Laid-Open Publication No. 2009-0045142
(Patent Document 2) Japanese Patent Laid-Open Publication No. 2006-081237

### SUMMARY OF THE INVENTION

An aspect of the present invention provides a motor driving device and method capable of generating a short pulse signal appropriate for driving a motor, more precisely controlling the short pulse signal even in the case that motor manufacturing conditions are changed, and arbitrarily controlling a control signal even after an integrated circuit is manufactured, by controlling a pulse width modulation (PWM) signal transferred from an operation controlling unit depending on a control signal applied from the outside to generate the short pulse signal.

According to an aspect of the present invention, there is provided a motor driving device including: an operation controlling unit generating a pulse width modulation (PWM) signal for controlling an operation of a motor; a driving controlling unit generating a short pulse signal using the PWM signal transferred from the operation controlling unit; and a power supplying unit supplying power to the motor using the short pulse signal, wherein the driving controlling unit controls the PWM signal depending on a control signal provided from the outside to generate the short pulse signal.

The driving controlling unit may include: a signal separating unit separating the PWM signal into a first signal and a second signal; a delay unit delaying the first signal depending on the control signal to generate a third signal; and a logic circuit unit generating the short pulse signal using the third signal and the second signal.

The driving controlling unit may include a delay unit having at least one delay cell in which a capacitor and a variable resistance element are connected to each other in parallel.

The variable resistance element may have a resistance varied depending on the control signal in order to delay the PWM signal.

According to another aspect of the present invention, there is provided a motor driving method including: transferring a PWM signal for controlling an operation of a motor from an operation controlling unit generating the PWM signal to a driving controlling unit; generating a short pulse signal by controlling the PWM signal depending on a control signal provided from the outside; and transferring the short pulse signal to the power supplying unit.

The generating of the short pulse signal may include: separating the PWM signal into a first signal and a second signal; delaying the first signal depending on the control signal to generate a third signal; and generating, by a logic circuit unit, the short pulse signal using the third signal and the second signal.

The generating of the short pulse signal may include: applying the control signal to a variable resistance element in the driving controlling unit; and delaying the PWM signal using a resistance varied depending on the control signal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating a motor driving device according to an embodiment of the present invention;

FIG. 2A is a block diagram illustrating a driving controlling unit of the motor driving device according to the embodiment of the present invention;

FIG. 2B is a block diagram illustrating an example of a logic circuit unit of FIG. 2A;

FIG. 3 is a graph for describing a result by an operation of the driving controlling unit shown in FIG. 2B;

FIG. 4 is a view illustrating an example of a delay cell in a delay unit shown in FIGS. 2A and 2B;

FIG. 5 is a flow chart provided in order to describe a motor driving method according to the embodiment of the present invention; and

FIGS. 6 and 7 are graphs for describing a pulse change depending on a control signal provided from the outside.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

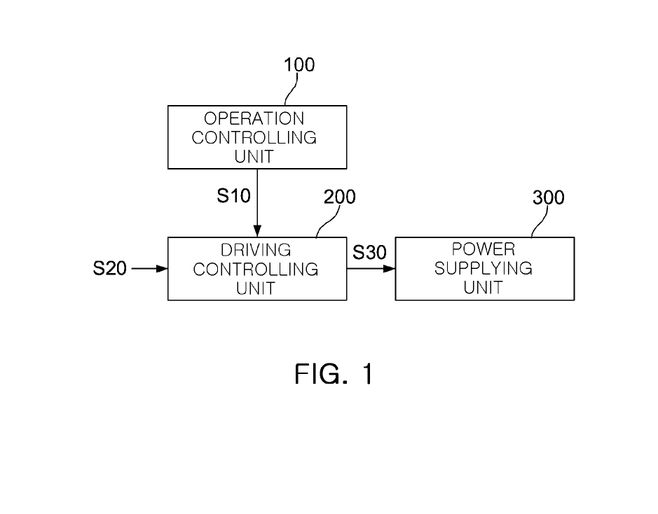

FIG. 1 is a block diagram illustrating a motor driving device according to an embodiment of the present invention.

As shown in FIG. 1, the motor driving device according to the present embodiment may include an operation controlling unit 100, a driving controlling unit 200, and a power supplying unit 300.

The operation controlling unit 100 may generate a pulse width modulation (PWM) signal S10 for controlling an operation of a motor and transfer the generated PWM signal to the driving controlling unit 200. The PWM signal S10 provided from the operation controlling unit 100 may be used to generate a short pulse signal S30 in the driving controlling unit 200.

More specifically, according to the embodiment of the present invention, a control signal S20 provided from the outside may be transferred to the driving controlling unit 200. Therefore, the driving controlling unit 200 may control the PWM signal S10 transferred from the operation controlling unit 100 to generate the short pulse signal S30. In addition, the driving controlling unit 200 may transfer the generated short pulse signal S30 to the power supplying unit 300.

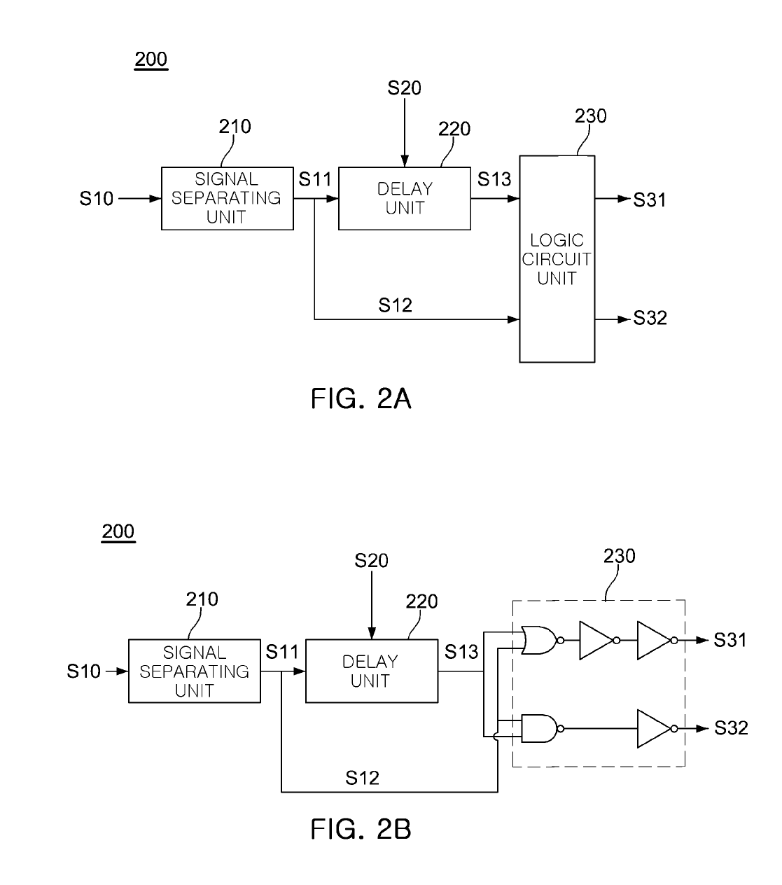

The power supplying unit 300 may receive the short pulse signal S30 from the driving controlling unit 200 and supply power to the motor. Hereinafter, the driving controlling unit 200 will be described in detail with reference to FIGS. 2A and 2B.

FIG. 2A is a block diagram illustrating a driving controlling unit of the motor driving device according to the embodiment of the present invention.

FIG. 2B is a block diagram illustrating an example of a logic circuit unit of FIG. 2A.

Referring to FIGS. 2A and 2B, the driving controlling unit 200 according to the present embodiment may include a signal separating unit 210, a delay unit 220, and a logic circuit unit 230.

The signal separating unit 210 may separate the PWM signal S10 provided from the operation controlling unit 100 into a first signal S11 and a second signal S12 and transfer the first signal S11 to the delay unit 220 and transfer the second signal S12 to the logic circuit unit 230. The delay unit 220 may delay the first signal S11 transferred from the signal separating unit 210 and use the delayed signal to generate a third signal S13.

The delay unit 220 may generate the third signal S13 depending on the first signal S11 separated by the signal separating unit 210 and the control signal S20 provided from the outside. More specifically, the delay unit 220 may delay the first signal S11 depending on the control signal S20 provided from the outside to generate the third signal S13. A method of delaying the first signal will be described in detail below with reference to FIG. 4. The third signal S13 generated by the delay unit 220 may be transferred to the logic circuit unit 230.

The logic circuit unit 230 may use the third signal S13 transferred from the delay unit 220 and the second signal S12 separated by the signal separating unit 210. The logic circuit unit 230 may include at least one logic gate, wherein the logic gate may be configured of AND, OR, XOR, NOR, NAND, and NOR gates.

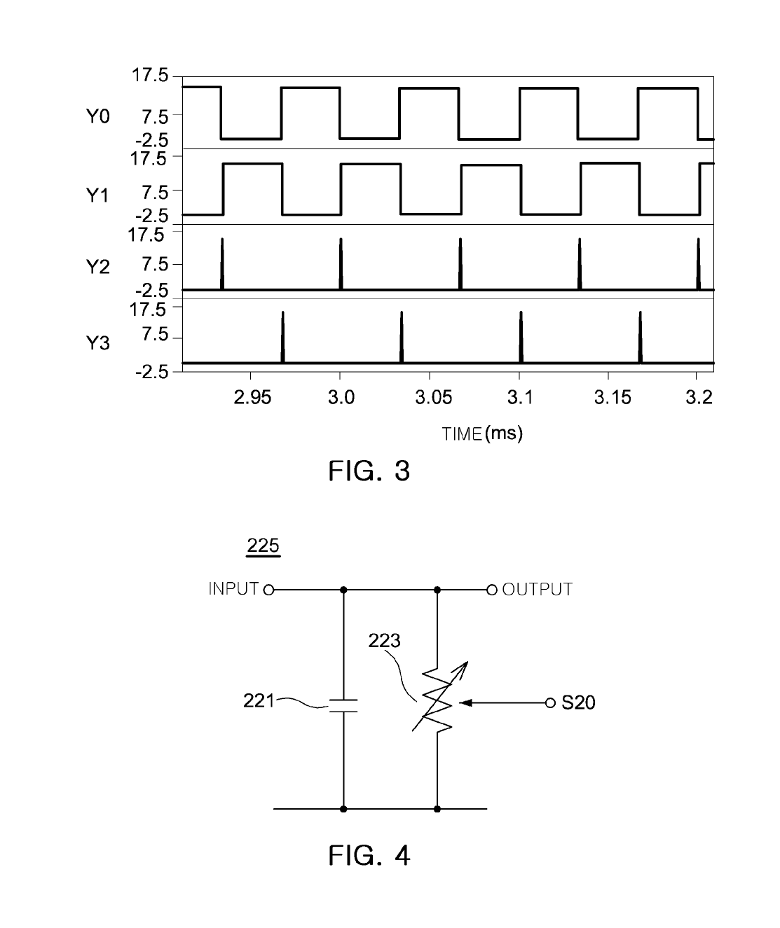

Referring to FIG. 2B, in the case in which the logic circuit unit 230 includes the NOR gate and the NAND gate, the logic circuit unit 230 may receive the third signal S13 transferred from the delay unit 220 and the second signal S12 as inputs of the NOR gate and the NAND gate, respectively. Then, the logic circuit unit 230 may generate short pulse signals by a delayed time at a rising edge and a falling edge of a pulse. Here, both of the short pulse signal S31 generated by the NOR gate and the short pulse signal S32 generated by the NAND gate may be transferred to the power supplying unit 300. Next, a description will be provided with reference to FIG. 3.

FIG. 3 is a graph for describing a result by an operation of the driving controlling unit shown in FIG. 2B.

Referring to FIGS. 3 and 2B, a relationship with pulse widths of each signal depending on a flow of time is shown as a graph. The first and second signals S11 and S12 correspond to Y0, and the third signal S13 in which the delay is controlled corresponds to Y1. When comparing Y0 and Y1 with each other, it can be appreciated that the delay is controlled in Y1 as compared with Y0. For example, in the case in which the logic circuit unit 230 includes the NOR gate and the NAND gate (See FIG. 2B), the third signal S13 and the second signal S12 are transferred to the two gates and then pass through the two gates, such that two short pulse signals S31 and S32 are generated. These correspond to Y2 and Y3 of FIG. 3. That is, an on-time of the pulse is decreased through the two short pulse signals S31 and S32, whereby driving efficiency of the motor may be improved and temperature characteristics of the motor may be stabilized.

FIG. 4 is a view illustrating an example of a delay cell in a delay unit shown in FIGS. 2A and 2B.

Referring to FIG. 4, the delay cell 225 according to the present embodiment may include a capacitor 221 and a variable resistance element 223 connected to each other in parallel in order to control the delay.

One or more delay cells 225 may be connected in series with each other to control the delay time. The delay cells 225 connected in series with each other may configure the delay unit 220.

The variable resistance element 223 may have a level of resistance varied depending on the control signal S20 provided from the outside in order to delay the PWM signal. The variable resistance element 223 may include a transistor as an example. For example, the control signal S20 provided from the outside may be applied to the transistor, and a resistance value varied depending on the control signal S20 may be controlled. Therefore, the first signal S11 may be delayed to generate the third signal S13.

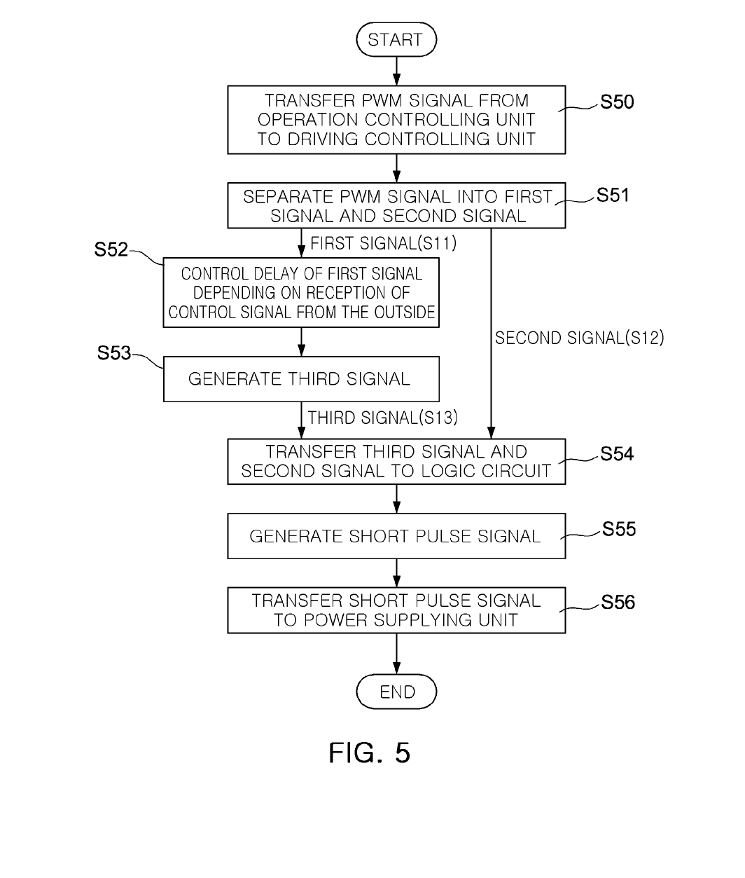

FIG. 5 is a flow chart provided in order to describe a motor driving method according to the embodiment of the present invention.

Referring to FIG. 5, the PWM signal generated by the operation controlling unit 100 is transferred to the driving controlling unit 200 in order to control an operation of the motor of the motor driving device (S50).

The signal separating unit 210 separates the PWM signal into the first signal S11 and the second signal S12 (S51). Meanwhile, the control signal S20 provided from the outside is transferred to the delay unit 220 (S52). The first signal S11 is delayed depending on the control signal S20 to generate the third signal S13 (S53).

The logic circuit unit 230 receives the third signal S13 and the second signal S12 (S54) and generates the short pulse signal through the gates present therein (S55).

In an example of S53 to S55, the control signal S20 provided from the outside is applied to the variable resistance element 223 in the driving controlling unit 200 and the variable resistance element 223 has a resistance value varied depending on the control signal S20 in order to delay the PWM signal, whereby the short pulse signal may be generated.

The short pulse signal generated through the above-mentioned process is transferred to the power supplying unit 300 (S56).

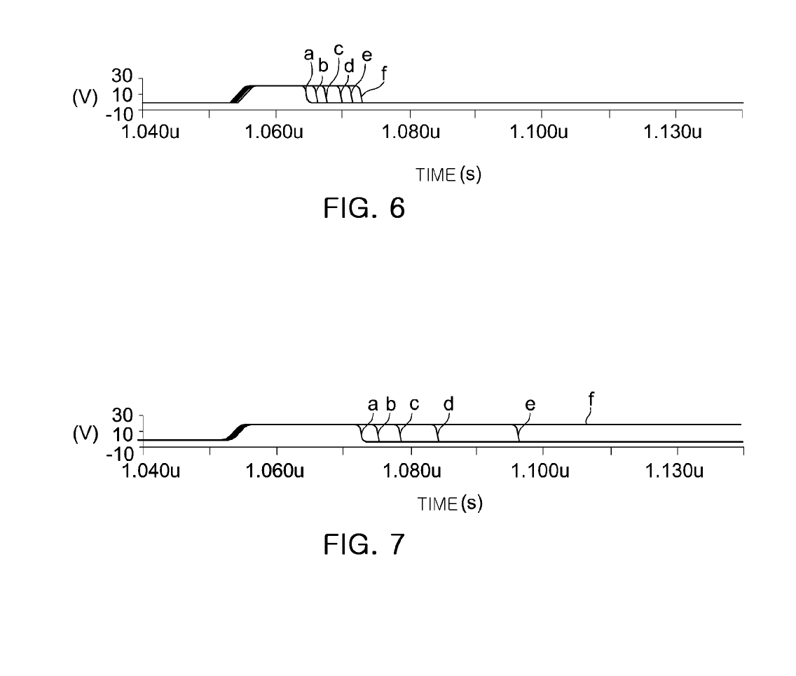

FIGS. 6 and 7 are graphs for describing a pulse change depending on a control signal provided from the outside.

As shown in FIGS. 6 and 7, a short pulse signal of which a pulse width is controlled may be generated using the control signal S20 provided from the outside.

In FIG. 6, in the case in which the control signals S20 corresponding to a to f and provided from the outside are determined to be voltage signals, for example, a, b, c, d, e, and f are 17, 17.2, 17.4, 17.6, 17.8, and 18 in volt (V) units, respectively. It can be appreciated that widths of the pulses are different depending on the voltage signals.

In FIG. 7, in the case in which the control signals S20 corresponding to a to f and provided from the outside are determined to be voltage signals, for example, a, b, c, d, e, and f are 19.2, 19, 18.8, 18.6, 18.4, and 18.2 in a volt (V) unit, respectively. It could be appreciated that widths of the pulse are different depending on the voltage signals.

That is, the short pulse signal of which the pulse width is controlled is generated depending on the control signal S20 provided from the outside, whereby the short pulse signal may be more precisely controlled even in the case that motor manufacturing conditions are changed and the control signal may be arbitrarily controlled even after an integrated circuit is manufactured.

As set forth above, according to the embodiment of the present invention, the PWM signal provided from the operation controlling unit is controlled using the voltage signal applied from the outside to generate the short pulse signal, whereby the short pulse signal may be more precisely controlled even in the case that motor manufacturing conditions are changed and the control signal may be arbitrarily controlled even after an integrated circuit is manufactured.

In addition, a structure of the motor driving device is simplified, whereby a time required for developing the motor driving device may be decreased.

While the present invention has been shown and described in connection with the embodiments, it will be apparent to those skilled in the art that modifications and variations can be made without departing from the spirit and scope of the invention as defined by the appended claims.

What is claimed is:

1. A motor driving device comprising:
an operation controlling unit generating a pulse width modulation (PWM) signal for controlling an operation of a motor;
a driving controlling unit generating a short pulse signal using the PWM signal transferred from the operation controlling unit; and
a power supplying unit supplying power to the motor using the short pulse signal,
wherein the driving controlling unit controls the PWM signal depending on a control signal provided from the outside to generate the short pulse signal.

2. The motor driving device of claim 1, wherein the driving controlling unit includes:
a signal separating unit separating the PWM signal into a first signal and a second signal;
a delay unit delaying the first signal depending on the control signal to generate a third signal; and
a logic circuit unit generating the short pulse signal using the third signal and the second signal.

3. The motor driving device of claim 1, wherein the driving controlling unit includes a delay unit having at least one delay cell in which a capacitor and a variable resistance element are connected to each other in parallel.

4. The motor driving device of claim 3, wherein the variable resistance element has a resistance varied depending on the control signal in order to delay the PWM signal.

5. A motor driving method comprising:
transferring a PWM signal for controlling an operation of a motor from an operation controlling unit generating the PWM signal to a driving controlling unit;
generating a short pulse signal by controlling the PWM signal depending on a control signal provided from the outside; and
transferring the short pulse signal to the power supplying unit.

6. The motor driving method of claim 5, wherein the generating of the short pulse signal includes:
separating the PWM signal into a first signal and a second signal;
delaying the first signal depending on the control signal to generate a third signal; and
generating, by a logic circuit unit, the short pulse signal using the third signal and the second signal.

7. The motor driving method of claim 5, wherein the generating of the short pulse signal includes:
applying the control signal to a variable resistance element in the driving controlling unit; and
delaying the PWM signal using a resistance varied depending on the control signal.
